(19) United States
(12) Patent Application Publication
(10) Pub. No.: US 2025/0278627 A1
(43) Pub. Date: Sep. 4, 2025

(54) End-To-End Graph Convolution Network

(71) Applicant: NAVER CORPORATION, Gyeonggi-do (KR)

(72) Inventors: Julien PEREZ, Grenoble (FR); Morgan FUNTOWICZ, Issy-lES-moulineaux (FR)

(73) Assignee: NAVER CORPORATION, Gyeonggi-do (KR)

(21) Appl. No.: 19/210,161

(22) Filed: May 16, 2025

Related U.S. Application Data
(63) Continuation of application No. 17/174,976, filed on Feb. 12, 2021.

(30) Foreign Application Priority Data
Apr. 9, 2020 (EP) 20315140.2

(51) Int. Cl. G06N 3/08; G06F 40/284; G06N 3/044; G06N 3/045

(52) U.S. Cl. CPC G06N 3/08; G06F 40/284; G06N 3/044; G06N 3/045

(57) ABSTRACT

A natural language sentence includes a sequence of tokens. A system for entering information provided in the natural language sentence to a computing device includes a processor and memory coupled to the processor, the memory including instructions executable by the processor implementing: a contextualization layer configured to generate a contextualized representation of the sequence of tokens; a dimension-preserving convolutional neural network configured to generate an output matrix from the contextualized representation; and a graph convolutional neural network configured to: use the matrix to form a set of adjacency matrices; and generate a label for each token in the sequence of tokens based on hidden states for that token in a last layer of the graph convolutional neural network.

### CROSS-REFERENCE TO RELATED APPLICATIONS

This application is a continuation of U.S. application Ser. No. 17/174,976, filed on Feb. 12, 2021, which claims the benefit of European Patent Application No. EP20315140.2, filed on Apr. 9, 2020. The entire disclosure of the application referenced above is incorporated herein by reference.

### FIELD

This disclosure relates to methods and systems for natural language processing. In particular, this disclosure relates to a neural network architecture that transforms an input sequence of words to a corresponding graph, and applies methods of graph learning on the constructed graph. The constructed model is applied to tasks of sequence tagging and classification.

### BACKGROUND

Discrete sequence processing is a task of natural language understanding. Some natural language processing problems, such as part-of-speech tagging, chunking, named entity recognition, syntactic parsing, natural language inference, and extractive machine reading, may be formalized as a sequence labeling and sequence classification task. Solutions to these problems provide improvements to numerous applications related to text understanding like dialog systems and information retrieval.

Natural language processing may include use of recurrent neural networks. Recurrent neural networks that include an encoder that reads each symbol of an input sequence sequentially to update its hidden states have been models used for natural language processing. After reading the end of a sequence, the hidden state of the recurrent neural network may be a summary of the input sequence. Advantageously, the encoder operates bi-directionally and may further include an attention mechanism to contextualize the hidden state of the encoder.

However, recognizing long range dependencies between sentences and paragraphs of a text, which may aid achieving automatic text comprehension, may be a difficult task. For example, performing global inference between a concept mentioned in different sections of a document may be challenging. Also, multi-hop inference may not be possible.

Graph convolutional neural networks have been proposed to provide global inference in sentence understanding tasks. These models may require the input text to be transformed into graph structures, which represent words as nodes and include weighted links between nodes. However, this transformation to a graph structure may be performed in a hand-crafted manner, often employing diverse third party systems.

### SUMMARY

In a feature, a novel end-to-end differentiable model of graph convolution is proposed. This approach allows the system to capture dependencies between words in an unsupervised manner. In contrast to methods of the prior art, the graph structure computed from the input sequence is a latent variable.

The described architecture allows for efficient multi-task learning in that the system learns graph encoder parameters only once and trains task-specific differentiable message-passing parameters by using the output of the graph encoders.

The proposed approach employs a fully differentiable pipeline for end-to-end message-passing inference composed with node contextualization, graph learning and a step of inference. The present application can be used in a multitask setting for joint graph encoder learning and possible unsupervised pre-training. The present application enables extraction of grammatically relevant relationships between tokens in an unsupervised manner.

The disclosed neural network system may be applied to locate tokens in natural language sentences that correspond to keys of a database and to enter the identified tokens into the database under the respective key. The present application may also be applied to provide labels for tokens of a natural language statement to a form interface such that the form interface may employ the labels of the tokens to identify and fill slots where a respective token is to be entered.

In a feature, a system for entering information provided in a natural language sentence to a computing device is provided. The natural language sentence, including a sequence of tokens, is processed by a contextualization layer configured to generate a contextualized representation of the sequence of tokens. A dimension-preserving convolutional neural network is configured to employ the contextualized representation to generate output corresponding to a matrix which is employed by a graph convolutional neural network as a set of adjacency matrices. The system is further configured to generate a label for each token in the sequence of tokens based on hidden states for the token in the last layer of the graph convolutional neural network.

In further features, the system may further include a database interface configured to enter a token from the sequence of tokens in a database by employing the label of the token as a key. The graph convolutional neural network is trained with a graph-based learning algorithm for locating, in the sequence of tokens, tokens that correspond to respective labels of a set of predefined labels.

In further features, the system may include a form interface configured to enter a token from the sequence of tokens in at least one slot of a form provided on the computing device, where the label of the token identifies the slot. The graph convolutional neural network is trained with a graph-based learning algorithm for tagging tokens of the sequence of tokens with labels corresponding to a semantic meaning.

In further features, the graph convolutional neural network includes a plurality of dimension-preserving convolution operators comprising a 1×1 convolution layer or a 3×3 convolution layer with a padding of one.

In further features, the graph convolutional neural network includes a plurality of dimension-preserving convolution operators comprising a plurality of DenseNet blocks. In further features, each of the plurality of DenseNet blocks includes a pipeline of a batch normalization layer, a rectified linear units layer, a 1×1 convolution layer, a batch normalization layer, a rectified linear units layer, a k×k convolution layer (k being an integer greater than or equal to 1), and a dropout layer.

In further features, the matrix generated by the dimension-preserving convolutional neural network is a multi-adjacency matrix including an adjacency matrix for each relation of a set of relations, where the set of relations corresponds to output channels of the graph convolutional neural network.

In further features, the graph-based learning algorithm is based on a message-passing framework.

In further features, the graph-based learning algorithm is based on a message-passing framework, where the message-passing framework is based on calculating hidden representations for each token and for each relation by accumulating weighted contributions of adjacent tokens for the relation. The hidden state for a token in the last layer of the graph convolutional neural network is obtained by accumulating the hidden states for the token in the previous layer over all relations.

In further features, the graph-based learning algorithm is based on a message-passing framework, where the message-passing framework is based on calculating hidden states for each token by accumulating weighted contributions of adjacent tokens, where each relation of the set of relations corresponds to a weight.

In further features, the contextualization layer includes a recurrent neural network. The recurrent neural network may be an encoder neural network employing bidirectional gated rectified units.

In further features, the recurrent neural network generates an intermediary representation of the sequence of tokens that is fed to a self-attention layer in the contextualization layer.

In further features, the graph convolutional neural network employs a history-of-word approach that employs the intermediary representation.

In further features, a method for entering information provided as a natural language sentence to a computing device is provided, the natural language sentence including a sequence of tokens. The method includes constructing a contextualized representation of the sequence of tokens by a recurrent neural network, processing an interaction matrix constructed from the contextualized representation by dimension-preserving convolution operators to generate output corresponding to a matrix, employing the matrix as a set of adjacency matrices in a graph convolutional neural network, and generating a label for each token in the sequence of tokens based on values of the last layer of the graph convolutional neural network.

In a feature, a system for entering information provided in a natural language sentence to a computing device is described. The natural language sentence includes a sequence of tokens. The system includes a processor and memory coupled to the processor, the memory including instructions executable by the processor implementing: a contextualization layer configured to generate a contextualized representation of the sequence of tokens; a dimension-preserving convolutional neural network configured to generate an output matrix from the contextualized representation; and a graph convolutional neural network configured to: use the matrix to form a set of adjacency matrices; and generate a label for each token in the sequence of tokens based on hidden states for that token in a last layer of the graph convolutional neural network.

In further features, a database interface is configured to enter a token from the sequence of tokens into a database and including the label of the token as a key, where the graph convolutional neural network is configured to execute a graph-based learning algorithm trained to locate, in the sequence of tokens, tokens that correspond to respective labels in a set of predetermined labels.

In further features, a form interface is configured to enter, into a field of a form, a token from the sequence of tokens, wherein the label of the token identifies the field, where the graph convolutional neural network is configured to execute a graph-based learning algorithm trained to tag tokens of the sequence of tokens with labels.

In further features, the graph convolutional neural network includes a plurality of dimension-preserving convolution operators including one of (a) a 1×1 convolution layer and (b) a 3×3 convolution layer with a padding of one.

In further features, the graph convolutional neural network includes a plurality of dimension-preserving convolution operators including a plurality of DenseNet blocks.

In further features, each of the plurality of DenseNet blocks includes a batch normalization layer, a rectified linear unit layer, a 1×1 convolution layer, a batch normalization layer, a rectified linear unit layer, a k×k convolution layer, and a dropout layer, where k is an integer greater than or equal to 1.

In further features, the matrix is a multi-adjacency matrix including an adjacency matrix for each relation of a set of relations, the set of relations corresponding to output channels of the graph convolutional neural network.

In further features, the graph-based learning algorithm executes message-passing.

In further features, the message passing includes calculating hidden representations for each token and for each relation by accumulating weighted contributions of adjacent tokens for that relation, where the hidden state for a token in a layer of the graph convolutional neural network is calculated by accumulating the hidden states for the token in a previous layer of the graph convolutional neural network over all of the relations.

In further features, the message passing includes calculating hidden states for each token by accumulating over weighted contributions of adjacent tokens, where each relation corresponds to a weight value.

In further features, the contextualization layer includes a recurrent neural network.

In further features, the recurrent neural network includes bidirectional gated recurrent units.

In further features, the recurrent neural network generates an intermediary representation of the sequence of tokens, and where the contextualization layer further includes a self-attention layer configured to receive the intermediary representation and to generate the contextualized representation based on the intermediate representation.

In further features, the graph convolutional neural network is configured to execute a history-of-word algorithm.

In further features, the memory further includes instructions executable by the processor implementing a word encoder configured to encode the sequence of tokens into vectors, where the contextualization layer is configured to generate the contextualized representation based on the vectors.

In a feature, a method for entering information provided in a natural language sentence to a computing device is described. The natural language sentence includes a sequence of tokens. The method includes: constructing a contextualized representation of the sequence of tokens by a recurrent neural network; processing an interaction matrix constructed from the contextualized representation by dimension-preserving convolution operators to generate an output corresponding to a matrix; using the matrix as a set of adjacency matrices in a graph convolutional neural network; and generating a label for each token in the sequence of tokens based on values of a last layer of the graph convolutional neural network.

In further features, the method further includes: entering a token from the sequence of tokens into a database and including the label of the token as a key, where the graph convolutional neural network executes a graph-based learning algorithm trained to locate, in the sequence of tokens, tokens that correspond to respective labels in a set of predetermined labels.

In further features, the method further includes: entering, into a field of a form, a token from the sequence of tokens, wherein the label of the token identifies the field, where the graph convolutional neural network executes a graph-based learning algorithm trained to tag tokens of the sequence of tokens with labels.

In further features, the graph convolutional neural network includes a plurality of dimension-preserving convolution operators including one of (a) a 1×1 convolution layer and (b) a 3×3 convolution layer with a padding of one.

In further features, the graph convolutional neural network includes a batch normalization layer, a rectified linear unit layer, a 1×1 convolution layer, a batch normalization layer, a rectified linear unit layer, a k×k convolution layer, and a dropout layer, where k is an integer greater than or equal to 1.

In a feature, a system configured to enter information provided in a natural language sentence is described. The natural language sentence comprising a sequence of tokens. The system includes: a first means for generating a contextualized representation of the sequence of tokens; a second means for generating an output matrix from the contextualized representation; and a third means for: forming a set of adjacency matrices from the matrix; and generating a label for each token in the sequence of tokens based on hidden states for that token.

### BRIEF DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 illustrates a block diagram of a neural network system for token contextualization, graph construction, and graph learning;

FIG. 2 illustrates a block diagram of a neural network system for entering information provided in a natural language sentence to a database;

FIG. 3 illustrates a block diagram of a neural network system for entering information provided in a natural language sentence to a form;

FIG. 4 illustrates a process flow diagram of a method of training a neural network system for node contextualization, graph construction, and graph learning;

FIG. 5 illustrates a process flow diagram of a method of entering information provided as a natural language sentence to a form or a database;

FIG. 6 displays matrix entries of a multi-adjacency matrix;

FIG. 7 shows grammatical dependencies produced by a method for an example sentence;

FIG. 8 shows latent adjacency relations generated for the example sentence; and

FIG. 9 illustrates an example architecture in which the disclosed methods and systems may be implemented.

### DETAILED DESCRIPTION

The present application includes a novel end-to-end graph convolutional neural network that transforms an input sequence of words into a graph via a convolutional neural network acting on an interaction matrix generated from the input sequence. The graph structure is a latent dimension. The present application further includes a novel method of graph learning on the constructed graph. The constructed model is applied to tasks of sequence tagging and classification.

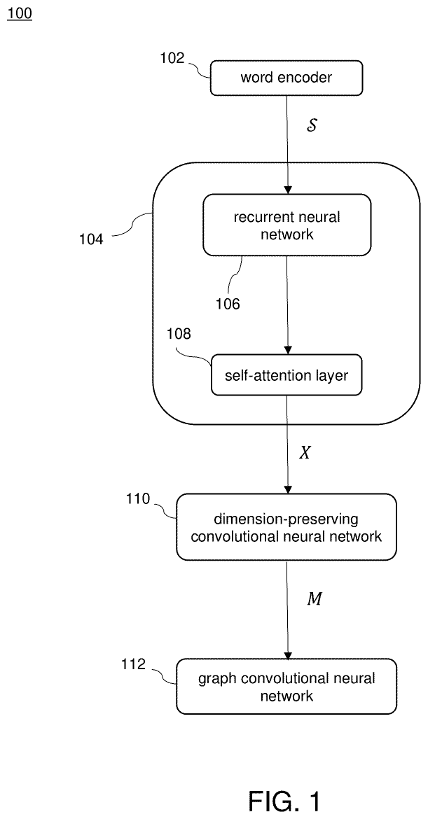

FIG. 1 shows a natural language processing system 100 including an end-to-end graph convolutional neural network. The system includes a word encoder 102 configured to receive an input sequence of words or tokens, W={w₁,w₂, . . . , wₙ}, where wᵢ ∈V with V being a vocabulary. W may form a sentence such as a declarative sentence or a question sentence.

The word encoder 102 is configured to encode W in a set of vectors S (an encoded sequence) that is provided to the contextualization layer 104. Contextualization layer 104 generates a contextualized representation of W based on the encoded sequence S. Output of the contextualization layer 104 (a contextualized representation) is input to a dimension-preserving convolutional neural network 110 that produces a multi-adjacency matrix from the contextualized representation.

Multi-adjacency matrix M describes relationships between each pair of words in W. Multi-adjacency matrix M is employed by a graph convolutional neural network 112 in a message-passing framework for the update between hidden layers, yielding a label for each token in the sequence of tokens.

In various implementations, the sequence of words or tokens W may be received from a user via an input module, such as receiving typed input or employing speech recognition. The sequence W may be received, for example, from a mobile device (e.g., a cellular phone, a tablet device, etc.) in various implementations.

The word encoder 102 embeds words in W in a corresponding set of vectors S={x₁,x₂, . . . ,xₜ, . . . ,xₛ}. Using a representation of vocabulary V, words are converted by the word encoder 102 to vector representations, for example via one shot encoding that produces sparse vectors of length equal to the vocabulary. These vectors may further be converted by the word encoder 102 to dense word vectors of much smaller dimensions. In embodiments, the word encoder 102 may perform word encoding using, for example, fasttext word encoding, as described in Edouard Grave, “Learning Word Vectors for 157 Languages”, Proceedings of the International Conference on Language Resources and Evaluation (LREC), 2018, which is incorporated herein in its entirety. In other embodiments, Glove word encoding may be used, as described in Pennington et al. “Glove: Global Vectors for Word Representation”, Proceedings of the 2014 Conference on Empirical Methods in Natural Language Processing (EMNLP), 2014, which is incorporated herein in its entirety.

In various implementations, the word encoder 102 includes trainable parameters and may be trained along with the neural networks shown in FIG. 1 which are explained below. In other embodiments, the word encoder 102 generates representations of W on a sub-word level.

### Contextualization Layer

The contextualization layer 104, including a recurrent neural network (RNN) 106, and, optionally, the self-attention layer 108, is configured to contextualize encoded sequence S. Contextualization layer 104 contextualizes S by sequentially reading each xₜ and updating a hidden state of the RNN 106. The RNN 106 acts as an encoder that generates in its hidden states an encoded representation of the encoded sequence S. In various implementations, the RNN 106 may be implemented as or include a bi-directional gated recurrent unit (biGRU), such as described in Cho et al. “Learning Phrase Representations using RNN Encoder-Decoder for Statistical Machine Translation”, Proceedings of the 2014 Conference on Empirical Methods in Natural Language Processing, EMNLP, 2014, which is incorporated herein in its entirety.

The RNN 106 sequentially reads each vector from the input sequence S and updates hidden states, such as according to the equation

$${z}_{t} = {σ}_{g} ( {W}_{z} {x}_{t} + {U}_{z} {h}_{t - 1} + {b}_{z} ) \qquad ( 1 a )$$

$${r}_{t} = {σ}_{g} ( {W}_{r} {x}_{t} + {U}_{r} {h}_{t - 1} + {b}_{z} ) \qquad ( 1 b )$$

$${h}_{t} = {z}_{t} ∘ {h}_{t - 1} + ( 1 - {z}_{t} ) ∘ {σ}_{h} ( {W}_{h} {x}_{t} + {U}_{h} ( {r}_{t} ∘ {h}_{t - 1} ) + {b}_{h} ) \qquad ( 1 c )$$

where hₜ ∈ [symbol] ^{e} is the vector of hidden states, zₜ ∈ [symbol] ^{e} is an updated gate vector, rₜ ∈ [symbol] ^{e} is a reset gate vector, o is the element-wise product, and σ_{g} and σₙ are activation functions. In various implementations, σ_{g} is a sigmoid function and σₙ is the hyperbolic tangent function. Generally speaking, the RNN 106 reads each element of the input sequence S sequentially and changes its hidden state by applying a non-linear activation function to its previous hidden state, taking into account the read element. The non-linear activation transformation according to Equations (1a)-(1c) includes an update gate zₜ that determines whether the hidden state is to be updated with a new hidden state, and a reset gate rₜ that determines whether the previous hidden state is to be ignored. When trained, the final hidden state of the RNN 106 corresponds to a summary of the input sequence S and thus also to a summary of input sentence W.

In the biGRU implementation, the RNN 106 performs the updates according to equations (1a) to (1c) twice, once starting from the first element of S to generate hidden state \vec{h}ₜ, and once with reversed update direction of equations (1a) to (1c), i.e., replacing subscripts t−1 with t+1, starting from the last element of S to generate hidden state [symbol] ₜ. Then, the hidden state of RNN 106 is the concatenation [\vec{h}ₜ; [symbol] ₜ],

The learning parameters of the RNN 106 according to equations (1a) to (1c) are w_{z}, wᵣ ∈ [symbol] ^{e×s}, U_{z}, Uᵣ, Uₕ ∈ [symbol] ^{e×s}, and b_{z}, b_{z}, bₕ ∈ [symbol] ^{e}. By employing both reading directions, \vec{h}ₜ takes into account context provided by elements previous to xₜ and [symbol] ₜ takes into account elements following xₜ.

In further processing, the contextualization layer 104 may optionally include the self-attention layer 108. In various implementations, a self-attention layer according to Yang et al. is employed, as described in Yang et al. “Hierarchical Attention Networks for Document Classification”, Proceedings of NAACL-HLT 2016, pages 1480-1489, which is incorporated herein in its entirety. In this implementation, the transformations

$${u}_{t} = {σ}_{h} ( {W}_{s a} {h}_{t} ) \qquad ( 2 a )$$

$${α}_{{u}_{t}}^{{t}^{′}} = \frac{{e}^{( {u}_{t}^{T} {u}_{{t}^{′}} )}}{{\sum }_{{t}^{″} = 1}^{T} {e}^{( {u}_{{t}^{″}}^{T} {u}_{t} ′ )}} \qquad ( 2 b )$$

$${v}_{t} = {\sum }_{{t}^{′} = 1}^{s} {α}_{{u}_{t}}^{{t}^{′}} {h}_{{t}^{′}} \qquad ( 2 c )$$

are applied to the hidden states of the RNN 106. In equations (2a) to (2c), σₙ is the hyperbolic tangent, and wₛₐ ∈ [symbol] ^{e×e} is a learned matrix. Calculating aᵤ^{t}′ involves scoring the similarity of uₜ with uₜ′ and normalizing, such as with a softmax function.

### Graph Construction

The convolutional neural network 110 is dimension-preserving and employs transformed sequence v ∈ [symbol] ^{s×e} yielded from the contextualization layer 104. The present application includes employing an interaction matrix X constructed from v by the convolutional neural network 110 to infer multi-adjacency matrix M of a directed graph.

From the transformed sequence v ∈ [symbol] ^{s×e}, interaction matrix X ∈ [symbol] ^{s×s×4e} is constructed according to

$${X}_{i j} = [ {v}_{i} ; {v}_{j} ; {v}_{i} - {v}_{j} ; {v}_{i} ∘ {v}_{j} ] \qquad ( 3 )$$

where “;” is the concatenation operation. From X, which may be referred to as an interaction matrix, the dimension-preserving convolutional neural network 110 constructs matrix M ∈ [symbol] which corresponds to a multi-adjacency matrix for a directed graph. The directed graph describes relationships between each pair of words of [symbol] . Here, | [symbol] | is the number of relations considered. In various implementations, | [symbol] |=1. In various implementations, the number of relations is | [symbol] |=3, 6, 9, 12, or 16. In this manner, dimension-preserving convolution operators of dimension-preserving convolutional neural network 110 are employed to induce a number of relationships between tokens of the input sequence W.

In various implementations, the dimension-preserving convolutional neural network 110 may be defined as f_{i,j,k}=max (wₖx_{i,j}, 0), which corresponds to a 1×1 convolution layer, such as the dimension-preserving convolutional layer described in Lin et al. “Network In Network”, arXiv: 1312.4400, which is incorporated herein in its entirety. In other implementations, the dimension-preserving convolutional neural network 110 includes a 3×3 convolution layer with a padding of 1. In various implementations, the 3×3 convolution layer includes a 3×3 convolutional layer called DenseNet Blocks, such as described in Huang et al “Densely Connected Convolutional neural networks”, 2017 IEEE Conference on Computer Vision and Pattern Recognition, pages 2261-2269, which is incorporated herein in its entirety. In this implementation, information flow between all layers of the dimension-preserving convolutional neural network 110 is improved by direct connections from any layer to all subsequent layers, so that each layer receives the feature maps of all preceding layers as input.

In various implementations, each block (layer) of the DenseNet Blocks comprises an input layer, a batch normalization layer, a rectified linear unit (ReLU) unit, a 1×1 convolution layer, followed by yet another batch normalization, a ReLU unit, a k×k convolution layer, and a dropout layer. Finally, a softmax operator may be employed on the rows of the obtained matrix to achieve training stability and to satisfy a normalization constraint for an adjacency matrix of a directed graph. The number of output channels of the dimension-preserving convolutional neural network 110, as described above, allows the system to induce a set of relations between the tokens of the input sequence.

Hence, the word encoder 102, the contextualization layer 104, and the dimension-preserving convolutional neural network 110 form a graph construction pipeline and generate a latent graph defined by multi-adjacency matrix M from input sentence W.

### Relational Graph Convolution

Multi-adjacency matrix M constructed by the dimension-preserving convolutional neural network 110 input to the graph convolutional neural network 112 that is trained with a graph-based learning algorithm. The graph convolutional neural network 112 executes the graph-based learning algorithm to implement graph-based learning on a graph with nodes each corresponding to a word of [symbol] (or token from [symbol] ) and having directed links defined by the multi-adjacency matrix M. The graph convolutional neural network 112 defines transformations that depend on a type and a direction of edges of the graph defined by the multi-adjacency matrix M.

The graph convolutional neural network 112 comprises L hidden layers having hidden states hᵢ^{l}, l=1, . . . , L. The model used by the graph convolutional neural network 112 may be a modification of a relational graph convolutional neural network to near-dense adjacency matrices, such as described in Schlichtkrull et al. “Modelling Relational Data with Graph Convolutional Networks” in European Semantic Web Conference, pages 593-607, 2018, which is incorporated herein in its entirety.

The model may be based on or include a differential message-passing framework. Differential message passing may be defined by

$${h}_{i}^{l + 1} = {σ}_{r} ( {\sum }_{m ∈ {M}_{i}} {g}_{m} ( {h}_{i}^{l} , {h}_{j}^{l} ) ) , \qquad ( 4 )$$

where hᵢ^{l} ∈ [symbol] ^{d(l)} is the hidden state of node vᵢ and d^{(l)} is the dimensionality of the representation of hidden layer l. In the general definition according to equation (4), Mᵢ is the set of incoming messages for node vᵢ, which is often chosen to be identical to the set of incoming edges at node vᵢ. Incoming messages contribute according to a weighting function gₘ applied to the hidden states hᵢ^{l} and hⱼ^{l}.

In various implementations, gₘ (hᵢ^{l}, hⱼ^{l})=Whⱼ^{l} with a weight matrix W including predetermined weights.

In various implementations, the model used by the graph convolutional neural network 112 may be given by

$${h}_{i}^{l + 1} = {σ}_{r} ( {\sum }_{r ∈ ℛ} {\sum }_{j ∈ {N}_{i}^{r}} \frac{1}{{c}_{r , i}} {W}_{r}^{l} {h}_{r , j}^{l} + {W}_{r , 0}^{l} {h}_{r , i}^{l} ) , \qquad ( 5 )$$

where Nᵢ^{r} is the set of indices of the neighbors of node i under relation r ∈ [symbol] and c_{i,r} is a problem-specific normalization constant. hᵢ^{l+1} is the hidden state of node vᵢ of the layer 1+1. In embodiments, c_{r,i} is learned. In other embodiments, c_{r,i} is chosen in advance.

As defined as an example in equation (5), the graph convolutional neural network 112 employs a message-passing framework that involves accumulating transformed feature vectors of neighboring nodes Nᵢ^{r} through a normalized sum.

To ensure that the representation of a node in layer l+1 depends on a corresponding representation at layer l, a single self-connection may be added to each node. Updates of the layers of the graph convolutional neural network 112 include evaluating equation 5 in parallel for every node in the graph. For each layer I+1, each node i is updated using the representation of each node at layer I. Multiple layers may be stacked to allow for dependencies across several relational steps.

In various implementations, the graph convolutional neural network 112 executes a novel message-passing scheme that may be referred to as separable message passing. Separable message passing includes treating each relation with a specific graph convolution. Separable message passing employs a parallel calculation of | [symbol] | hidden representations for each node. The hidden state for a token in the last layer is obtained by accumulating the | [symbol] | hidden representations for the token in the previous layer. The separable message passing may be defined by

$${h}_{r , i}^{l + 1} = {σ}_{r} ( {\sum }_{j ∈ {N}_{i}^{r}} \frac{1}{{c}_{r , i}} {W}_{r}^{l} {h}_{r , j}^{l} + {W}_{r , 0}^{l} {h}_{r , i}^{l} ) \qquad ( 6 a )$$

$${h}_{i}^{last} = {σ}_{r} ( {\sum }_{r ∈ ℛ} {h}_{r , i}^{L} ) , \qquad ( 6 b )$$

where equation (6a) is evaluated for all r ∈R. In equation (6a), c_{r,i} is a normalization constant as described above, and wᵣ^{l} and w_{r,0}^{l} are learned weight matrices.

In various implementations, the graph convolutional neural network 112 further executes a history-of-word approach (algorithm), such as described in Huang et al. “FusionNet: Fusing via Fully-Aware Attention with Application to Machine Comprehension”, Conference Track Proceedings of the 6th International Conference on Learning Representations, ICLR, 2018, which is incorporated herein in its entirety. Each node of the graph convolutional neural network 112 may be represented by the result of the concatenation

l(wᵢ)=[wᵢ;vₒ;hᵢ^{last}].

### Training of the System

Training of the system of FIG. 1 firstly includes training the graph construction pipeline of the contextualization layer 104 and the dimension-preserving convolutional neural network 110. Training the contextualization layer 104 includes training the RNN 106 and, optionally, training the self-attention layer 108.

Training of the system of FIG. 1 secondly includes training the graph convolutional neural network 112. The trained contextualization layer 104 and the trained convolutional neural network 112 can be used for diverse tasks so that pipelines for different tasks can share the parameters of the contextualization layer 104 and the convolutional neural network 112. This may reduce the expense for training the system of FIG. 1 for specific tasks.

For example, the system of FIG. 1 may be trained for specific tasks such as node classification and sequence classification, which are used in natural language processing. For the task of node classification, the relational graph convolutional neural network layers are stacked with a softmax activation function on the output of the last layer, and the following cross entropy loss is minimized on all labelled nodes,

$$ℒ = {\sum }_{i ∈ Y} {\sum }_{k = 1}^{K} {t}_{ik} log {h}_{ik}^{L} \qquad ( 7 )$$

where Y is the set of node indices and hᵢₖ^{L} is the k-th entry of the network output for the i-th node. The variable tᵢₖ denotes the ground truth label as obtained from the training set, corresponding to a supervised training of the system. The model with architecture as described above may be trained using stochastic gradient descent of [symbol] .

In various implementations, the training set is only partially annotated so that the model is trained in a semi-supervised manner.

When training the model with architecture according to FIG. 1 for sequence classification, the output of the relational graph convolutional layer may be taken as input to a sequence classification layer. In various implementations, a bi-directional long short-term memory layer, as explained in Hochreiter and Schmidhuber, “Long Short-Term Memory”, Neural Computation 98, pages 1735-1780, 1997, is used for the training. The above is incorporated herein in its entirety. In other implementations, a fully connected layer is used. The fully connected layer takes the result of a max pooling computed over the dimensions of the output node sequence. The categorical cross entropy of the predicted label associated with each sequence may be minimized during the training.

When trained, the system described with reference to FIG. 1 is able to infer relationships between individual elements of the input sequence. In particular, the model can leverage explicitly modelled sentence-range relationships and perform inference from it in a fully differential manner.

### Evaluation

During experiments performed on the system illustrated in FIG. 1, ablation tests were performed to measure the impact of the pre-processing by the sequence contextualization by the RNN 106 and self-attention layer 108.

To demonstrate the quality of the model described above with reference to FIG. 1, the system may be trained for the tasks of named entity recognition and slot filling, which are both instances of a node classification task.

The system may be trained for the named entity recognition task employing the dataset CoNLL-2003, described in Tjong Kim Sang and De Meulder, “Introduction to the CONLL-2003 Shared Task: Language-Independent Named Entity Recognition”, Proceedings of the Seventh Conference on Natural Language Learning at HLT-NAACL 2003. In this dataset, each word is tagged with the predefined labels of Person, Location, Organization, Miscellaneous, or Other. This training dataset includes 14987 sentences corresponding to 204567 tokens. A used validation set may include 3466 sentences and 51578 tokens and may be a part of the same dataset as the training dataset. The test dataset may include 3684 sentences and 46666 tokens. The BIO (beginning, inside, outside) annotation standard may be used. In this notation, the target variable counts a total of 9 distinct labels.

As a second demonstration, the system may be trained for the slot filling task with the ATIS-3 dataset. The slot filling task is to localize specific entities in a natural-language-formulated request, i.e., the input sentence. Thus, given a specific semantic concept, e.g., a departure location, the presence of a specific entry corresponding to the semantic concept is determined and the corresponding entry is identified. The system is trained to detect the presence of particular information (a “slot”) in the input sequence W and to identify the corresponding information. For example, in the sentence “I need to find a flight for tomorrow morning from Munich to Rome”, Munich should be entered into the slot of a departure location and Rome should be entered into the slot of an arrival location. Also in this task, the BIO annotation standard may be used. The dataset counts a total of 128 unique tags created from the original annotations according to methods described in Raymond and Riccardi, “Generative and Discriminative Algorithms for Spoken Language Understanding”, 8th Annual Conference of the International Speech Communication Association (INTERSPEECH), 2007, pages 1605-1608, where each word of the sequence is associated with a unique tag.

Table 1 includes example parameters used for training for the named entity recognition task (NER) and the slot filling task (SF).

TABLE 1

| Parameter | NER | SF |
|---|---|---|
| batch size | 32 | 8 |
| dropout | 0.4 | 0.2 |
| L2 | 1e−4 | 1e−4 |
| #relations | 9 | 16 |
| #precontext layers | 1 | 1 |
| hidden dimension | 64 | 64 |
| convolution type | Conv1x1 | DenseNet |
| lexicon | fasttext.en.300d | Glove.6B.300d |

In training for each task, the cross entropy loss according to Eq. (7) may be minimized, such as using the Adam optimization algorithm and stochastic gradient descent algorithm. Furthermore, a greedy-decoding method may be employed for both tasks. The probability of each token being the first and the last element of the answer span is computed using two fully connected layers applied to the output of a biGRU (bidirectional gate recurrent unit) computed over the concatenation.

Table 2 includes accuracy results for the named entity recognition task of the systems of the present disclosure in comparison with other systems. Table 2 displays results for the system described herein indicated as E2E-GCN of an embodiment employing a graph convolutional neural network employing message passing according to Eq. (5), and results indicated as E2E-Separable-GCN of an embodiment employing a graph convolutional neural network employing separable message passing according to Eq. (6a) and (6b).

TABLE 2

| System | Accuracy |
|---|---|
| HMM + Maxent (Florian et al. 2003) | 88.76 |
| MaxEnt (Chieu & Ng, 2003) | 88.31 |
| Semi-supervised (Ando & Zhang, 2005) | 89.31 |
| Conv-CRF(SG) (Collobert et al. 2011) | 89.59 |
| CRF with LIE (Passos et al. 2014) | 90.90 |
| BI-LSTM-CRF(SG) (Huang et al. 2015) | 90.10 |
| E2E-GCN (described herein) | 90.40 |
| E2E-Separable-GCN (described herein) | 91.7 |

As illustrated by Table 2, the systems of the present application provide more accurate results than other systems.

Furthermore, some of the other systems of Table 2 rely on steps involving manual intervention of a user (e.g., programmer). The systems of the present application (E2E-GCN and E2E-separable-GCN), however, do not involve such steps yet provide an end-to-end pipeline.

Table 3 includes results of the systems E2E-GCN and E2E-Separable-GCN for the slot filling task for the ATIS-3 dataset in comparison with results of other systems by the achieved F₁ score, which is a measure of the accuracy of the classification.

TABLE 3

| System | F₁ |
|---|---|
| Elman | 94.98 |
| Jordan | 94.29 |
| Hybrid | 95.06 |
| CRF | 92.94 |
| R-CRF (Mesnil et al. 2015) | 96.46 |
| E2E-GCN (described herein) | 96.6 |
| E2E-Separable-GCN (described herein) | 97.7 |

Table 4 shows performance of the system trained for named entity recognition and the embodiment trained for slot filling in dependence on the number of relations |R|. Table 4 shows accuracy achieved for the named entity recognition task and the F₁ score for the slot filling task employing the E2E-Separable-GCN described herein with varying number of relations | [symbol] |. As is apparent, the optimal number of relations may be problem-dependent. For the named entity recognition task, nine relations may achieve optimal performance, while for the slot filling task the F₁-score may further increase with the number of considered relations.

TABLE 4

| \|R\| | NER | SF |
|---|---|---|
| 3 | 85.2 | 92.6 |
| 6 | 89.2 | 94.73 |
| 9 | 91.7 | 89.69 |
| 12 | 90.1 | 96.24 |
| 16 | 88.1 | 97.7 |

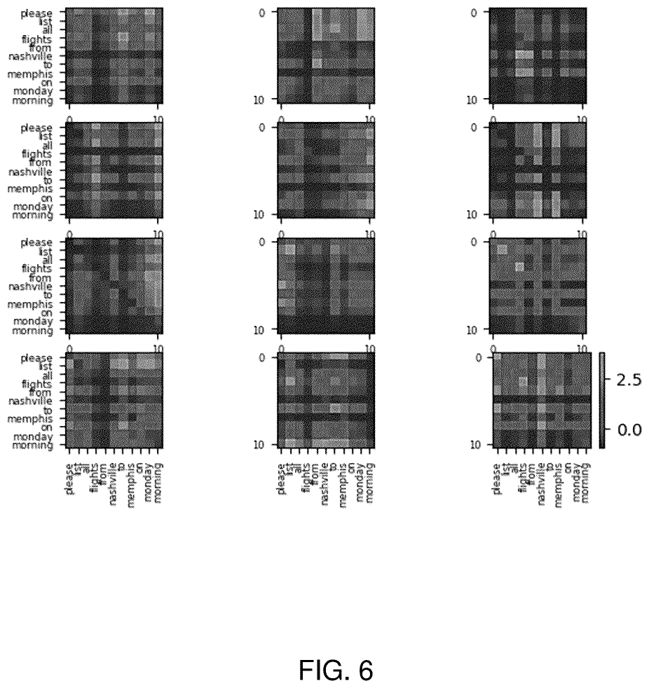

FIG. 6 illustrates entries of the multi-adjacency matrix for the sentence [symbol] “please list all flights from Nashville to Memphis on Monday morning” generated according to principles explained above for the slot filling task. The subfigures of FIG. 6 include greyscale-coded matrix values of Mᵢⱼ^{r} for r=0, . . . , 8.

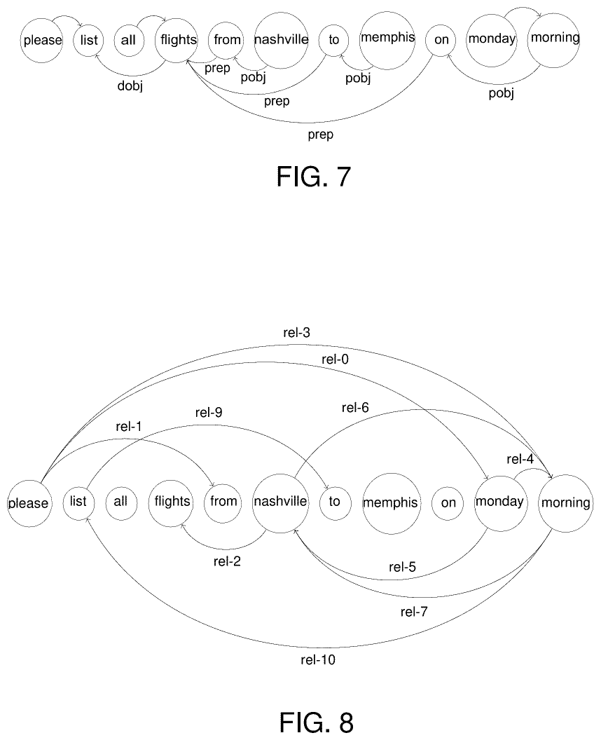

FIG. 7 visualizes, for the same sentence W as above, relationships produced by a different dependency parser, while FIG. 8 visualizes the relationships captured by a multi-adjacency matrix according to the present application. FIG. 7 shows a result of a different dependency parser by Kiperwasser and Goldberg, “Simple and Accurate Dependency Parsing Using Bidirectional LSTM Feature Representations”, TACL, 4, pages 313-327, code 116.

To produce FIG. 8 from adjacency matrix Mᵢⱼ encoding the sentence W, the pair of tokens {wᵢ, wⱼ} of maximum value such that x*ᵣ=argmax_{i,j} Mᵢⱼ^{r} is selected. FIG. 8 thus demonstrates that the disclosed systems are configured to extract grammatically relevant relationships between tokens in an unsupervised manner.

By comparing FIGS. 7 and 8, a number of important differences can be seen. Firstly, the other dependency parsers use queue stack systems to control the parsing process which imposes several restrictions as being based on a projective parsing formalism. In particular, this approach of the other dependency parsers implies that a dependency can have only one head (all arrows go to or from the word “flights”), represented as the arrow-heads in FIG. 7. In contrast, the systems described herein allows dependencies that have several heads as illustrated by the arrow-heads in FIG. 8.

Furthermore, due to the recurrent mechanism adopted by other dependency parsers, long-range dependencies between tokens may not be represented, as is apparent from FIG. 7. This limitation of the other dependency parsers prevent contextual information being passed across the sentence, whereas, as apparent from FIG. 8, the systems described herein allow sentence length dependencies to be modelled. In the model architecture, such as described with respect to FIG. 1, these long range dependencies are propagated by the graph convolution model across the sentence, which may explain the achieved improvements over other systems.

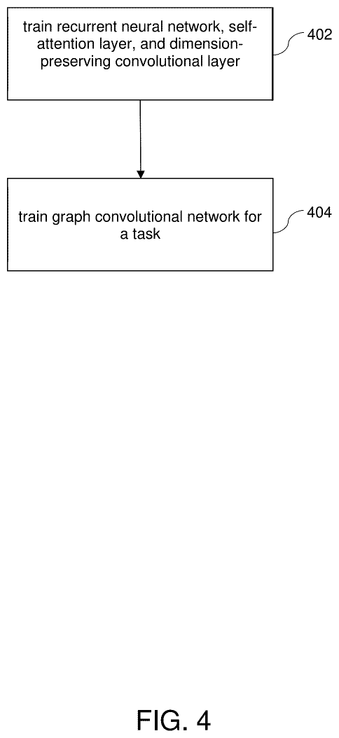

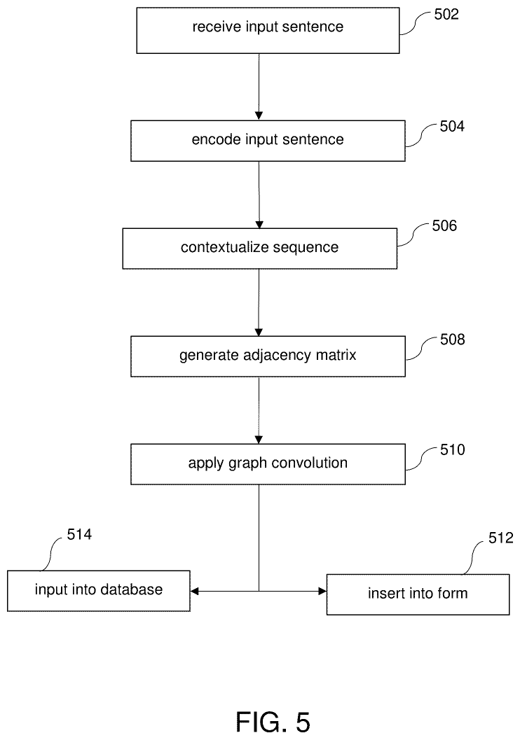

Further embodiments will now be described in detail in relation to the above and with reference to FIGS. 4 and 5, which are functional block diagrams illustrating computer-implemented methods 400 and 500, respectively.

Method 400 illustrated in FIG. 4 includes training at 402 the graph construction pipeline of the RNN 106, the self-attention layer 108, and the dimension-preserving convolutional neural network 110. Training is performed using a training dataset.

Method 400 further includes training at 404 the graph convolutional neural network 112 for a specific task, such as node classification or sequence classification. Training at 404 the graph convolutional neural network 112 includes evaluating a cross entropy loss such as cross entropy loss [symbol] from equation (7) for a training set and adjusting the hyperparameters of graph convolutional neural network 112, for example by stochastic gradient descent, to optimize [symbol] . Accuracy of the graph convolutional neural network 112 as currently trained may be evaluated on a validation set. Training may be stopped when the error on the validation dataset increases, as this is a sign of overfitting to the training dataset.

In various implementations, the graph construction pipeline and the graph convolutional neural network 112 are trained jointly employing the training set and the validation set.

In various implementations, the specific task is database entry. For this specific task, the training set may include natural language statements tagged with the predetermined keys of a database. In various implementations, the specific task is filling out a form (form filling) provided on a computing device. For this specific task, the training dataset may arise from a specific domain and include natural language statements corresponding to a request. The requests may correspond to information required by the form. In the training dataset, words in a natural language statement may be tagged with a semantic meaning of the word in the natural language statement.

Training the graph convolutional neural network 112 for a second specific task may only require repeating 404 for the second specific task while employing the same trained pipeline of the RNN 106, the self-attention layer 108, and the dimension-preserving convolutional neural network 110.

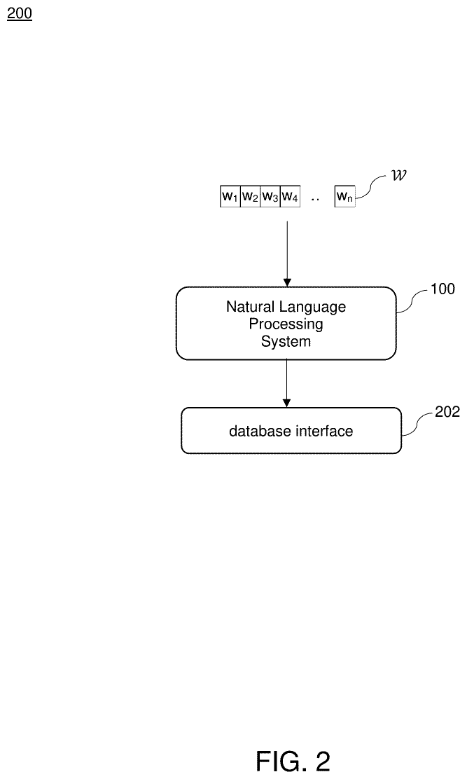

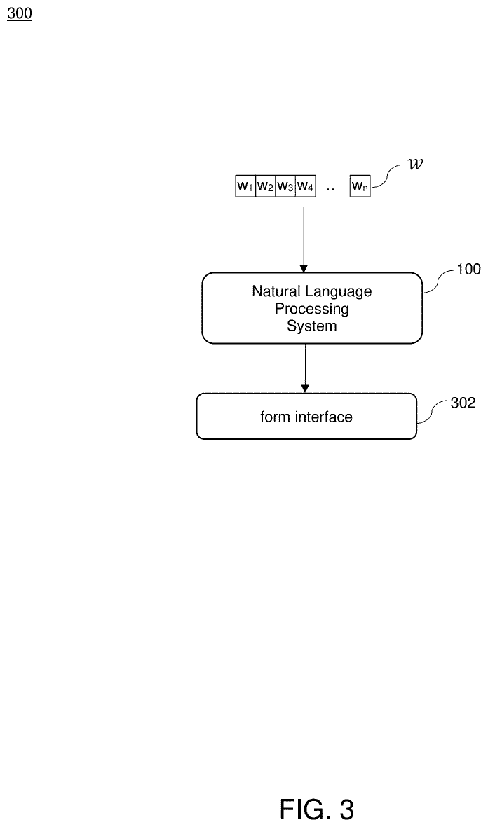

Method 500 illustrated in FIG. 5 relates to a method for entering information provided in a natural language sentence [symbol] to a computing device. More particularly, information provided in the natural language sentence [symbol] may be entered into a database stored on the computing device (e.g., by a database interface 202 as in FIG. 2) or may be entered in a form provided on the computing device (e.g., by a form interface 302 as in FIG. 3). FIG. 2 illustrates a block diagram of a neural network system for entering information provided in a natural language sentence to a database. FIG. 3 illustrates a block diagram of a neural network system for entering information provided in a natural language sentence to a form. In the example of FIG. 2, the database interface 202 is configured to enter a token from the sequence of tokens into a database and including the label of the token as a key, and the graph convolutional neural network is trained with a graph-based learning algorithm configured to locate, in the sequence of tokens, tokens that correspond to respective labels in a set of predetermined labels. In the example of FIG. 3, the form interface 302 is configured to enter, into a field of a form, a token from the sequence of tokens, wherein the label of the token identifies the field, and the graph convolutional neural network is trained with a graph-based learning algorithm configured to tag tokens of the sequence of tokens with labels.

Method 500 includes using neural networks trained according to the method 400 explained above. Method 500 includes receiving at 502 the natural language sentence W from computing device, such as input by a user. The natural language sentence may be input, for example, by typing or via speech.

At 504, the natural language sentence [symbol] is encoded in a corresponding sequence of word vectors [symbol] , for example by the word encoder 102 as explained above with reference to FIG. 1.

At 506, a sequence of contextualization steps is performed to word vectors S to produce a contextualized representation of the natural language sentence. Contextualization at 506 may employ feeding the word vectors to the contextualization layer 104 as explained with reference to FIG. 1.

At 508, the contextualized representation is put through a dimension-preserving convolutional neural network, such as dimension-preserving convolutional neural network 110, to construct a multi-adjacency matrix M including adjacency matrices for a set of relations [symbol] .

At 510, the generated multi-adjacency matrix is processed by a graph convolutional neural network, such as the graph convolutional neural network 112, described with reference to FIG. 1. The graph convolutional neural network may execute, for example, message passing according to equation (5) or separable message passing according to equation (6).

The method 500 at 512 includes using the output of the last layer of the graph convolutional neural network to enter a token from the natural language sentence in a database employing a label generated by the graph convolutional neural network as a key The graph convolutional neural network 112 has been trained with a training dataset tagged with the keys of the database.

The present application is also applicable to other applications, such as when a user has opened a form (e.g., a web form of an HTTP (hypertext transfer protocol) website. Entries of the web form are employed to identify slots (e.g., fields) to be filled by information contained in the natural language sentence corresponding to a request that may be served by the HTTP website. In this application, the method 500 includes at 514 identifying the presence of one or more words of the natural language that correspond to entries required in the form, and filling one or more slots of the form with one or more identified words, respectively. The word identification is performed using the systems trained and described herein.

For example, using the example of listing flights, as included in the ATIS-3 dataset, a web form may provide entries for a departure location and an arrival location. The method 500 may include detecting the presence of a departure location and/or an arrival location in the natural language sentence, and filling the web form with the corresponding words (departure and arrival locations) from [symbol] .

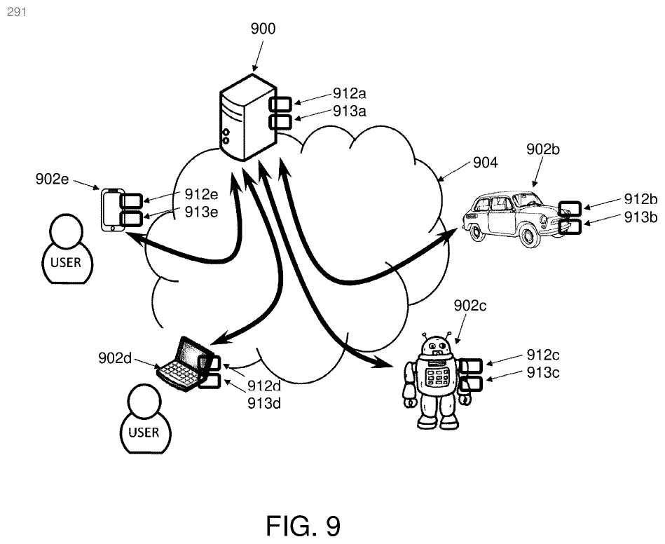

The above-mentioned systems, methods, and embodiments may be implemented within an architecture such as that illustrated in FIG. 9, which includes server 900 and one or more computing devices 902 that communicate over a network 904 (which may be wireless and/or wired), such as the Internet, for data exchange. The server 900 and the client devices 902 each include one or more processors 912 (912-a-912-e) and memory 913 (913-a-913-e), such as one or more hard disks. The computing devices 902 may be any type of computing devices configured to communicate electronically with the server 900, including an autonomous vehicle 902b, a robot 902c, a computer 902d, a cellular phone 902e, a tablet device, etc. The system according to the embodiments of FIGS. 1 and 2 may be implemented by a computing device including processor 912-a and memory 913-a storing program instructions coupled to the processor 912-a of the server 900.

The server 900 may receive a training set and use the processor(s) 912 to train the graph construction pipeline 106-110 and graph convolutional neural network 112. The server 900 may then store trained parameters of the graph construction pipeline 106-110 and graph convolutional neural network 112 in the memory 913.

For example, after the graph construction pipeline 106-110 and the graph convolutional neural network 112 are trained, a computing device 902 may provide a received natural language statement to the server 900. The server 900 uses the graph construction pipeline 106-110 and graph convolutional neural network 112 (and the stored parameters) to determine labels for words in the natural language statement. The server 900 may process the natural language statement according to the determined labels, e.g., to enter information in a database stored in memory 913 or to fill out a form and provide information based on the filled out form back to the computing device 902. Additionally or alternatively, the server 900 may provide the labels to the client device 902.

Some or all of the method steps described above may be implemented by a computer in that they are executed by (or using) one or more processors, microprocessors, electronic circuits, and/or processing circuitry.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “layer” or the term “network” may be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The methods and systems disclosed herewith allow for an improved natural language processing, in particular by improving inference on long-range dependencies and thereby improving word classification tasks and other types of tasks.

What is claimed is:

1. A system for entering information provided in a natural language sentence to a database or to a form provided on a computing device, the natural language sentence comprising a sequence of tokens, the system comprising:
an encoder neural network configured to encode the sequence of tokens in a set of vectors;
a contextualization layer configured to generate a contextualized representation of the sequence of tokens from the set of vectors;
a dimension-preserving convolutional neural network configured to employ the contextualized representation to generate output corresponding to a matrix; and
a graph convolutional neural network configured to employ the matrix as a set of adjacency matrices,
wherein the system is further configured to generate a label for each token in the sequence of tokens based on hidden states for the token in the last layer of the graph convolutional neural network,
wherein the encoder neural network, the contextualization layer, and the dimension-preserving convolutional neural network form a graph construction pipeline,
wherein the matrix defines a graph structure which is a latent variable of the graph construction pipeline,
wherein the system further comprises at least one of:
a database interface configured to enter a token from the sequence of tokens into the database, wherein entering the token comprises employing the label of the token as a key, wherein the graph convolutional neural network is trained with a graph-based learning algorithm for locating, in the sequence of tokens, tokens that correspond to respective labels of a set of predefined labels, and
a form interface configured to enter, into at least one slot of the form provided on the computing device, a token from the sequence of tokens, wherein the label of the token identifies the slot, wherein the graph convolutional neural network is trained with a graph-based learning algorithm for tagging tokens of the sequence of tokens with labels.

2. The system of claim 1, wherein the graph convolutional neural network comprises a plurality of dimension-preserving convolution operators comprising a 1×1 convolution layer or a 3×3 convolution layer with a padding of one.

3. The system of claim 1, wherein the graph convolutional neural network comprises a plurality of dimension-preserving convolution operators comprising a plurality of DenseNet blocks.

4. The system of claim 3, wherein each of the plurality of DenseNet blocks comprises a pipeline of a batch normalization layer, a rectified linear units layer, a 1×1 convolution layer, a batch normalization layer, a rectified linear units layer, a k×k convolution layer, and a dropout layer.

5. The system of claim 1, wherein the matrix is a multi-adjacency matrix comprising an adjacency matrix for each relation of a set of relations, and the set of relations corresponds to output channels of the graph convolutional neural network.

6. The system of claim 1, wherein the graph-based learning algorithm is based on a message-passing framework.

7. The system of claim 6, wherein the message-passing framework is based on calculating hidden representations for each token and for each relation by accumulating weighted contributions of adjacent tokens for the relation, wherein the hidden state for a token in the last layer of the graph convolutional neural network is obtained by accumulating the hidden states for the token in the previous layer over all relations.

8. The system of claim 6, wherein the message-passing framework is based on calculating hidden states for each token by accumulating over weighted contributions of adjacent tokens, wherein each relation of the set of relations corresponds to a weight.

9. The system of claim 1, wherein the contextualization layer comprises a recurrent neural network.

10. The system of claim 9, wherein the recurrent neural network is an encoder neural network employing bidirectional gated rectified units.

11. The system of claim 9, wherein the recurrent neural network generates an intermediary representation of the sequence of tokens, and wherein the contextualization layer further comprises a self-attention layer that is fed with the intermediary representation.

12. The system of claim 11, wherein the graph convolutional neural network employs a history-of-word approach that employs the intermediary representation.

13. A method for entering information provided in a natural language sentence to a database interface or to a form interface provided on a computing device, the natural language sentence comprising a sequence of tokens, the method comprising:
encoding, by an encoder neural network, the sequence of tokens in a set of vectors;
constructing, by a contextualization layer, a contextualized representation of the sequence of tokens from the set of vectors;
processing, by a dimension-preserving convolutional neural network, an interaction matrix constructed from the contextualized representation by dimension-preserving convolution operators to generate output corresponding to a matrix;
employing the matrix as a set of adjacency matrices in a graph convolutional neural network; and
generating a label for each token in the sequence of tokens based on values of the last layer of the graph convolutional neural network,
wherein the encoder neural network, the contextualization layer, and the dimension-preserving convolutional neural network form a graph construction pipeline,
wherein the matrix defines a graph structure which is a latent variable of the graph construction pipeline,
wherein the method further comprises at least one of:
employing output of the graph convolutional neural network to enter a token from the sequence of tokens into the database interface, wherein entering the token comprises employing the label of the token as a key, wherein the graph convolutional neural network is trained with a graph-based learning algorithm for locating, in the sequence of tokens, tokens that correspond to respective labels of a set of predefined labels; and
employing output of the graph convolutional neural network to enter, into at least one slot of the form interface, a token from the sequence of tokens, wherein the label of the token identifies the slot, wherein the graph convolutional neural network is trained with a graph-based learning algorithm for tagging tokens of the sequence of tokens with labels.

14. The method of claim 13, wherein the graph convolutional neural network comprises a plurality of dimension-preserving convolution operators comprising a 1×1 convolution layer or a 3×3 convolution layer with a padding of one.

15. The method of claim 13, wherein the graph convolutional neural network comprises a plurality of dimension-preserving convolution operators comprising a plurality of DenseNet blocks.

16. The method of claim 15, wherein each of the plurality of DenseNet blocks comprises a pipeline of a batch normalization layer, a rectified linear units layer, a 1×1 convolution layer, a batch normalization layer, a rectified linear units layer, a k×k convolution layer, and a dropout layer.

17. The method of claim 13, wherein the matrix is a multi-adjacency matrix comprising an adjacency matrix for each relation of a set of relations, and the set of relations corresponds to output channels of the graph convolutional neural network.

18. The method of claim 13, wherein the graph-based learning algorithm is based on a message-passing framework.

19. The method of claim 18, wherein the message-passing framework is based on calculating hidden representations for each token and for each relation by accumulating weighted contributions of adjacent tokens for the relation, wherein the hidden state for a token in the last layer of the graph convolutional neural network is obtained by accumulating the hidden states for the token in the previous layer over all relations.

20. The method of claim 18, wherein the message-passing framework is based on calculating hidden states for each token by accumulating over weighted contributions of adjacent tokens, wherein each relation of the set of relations corresponds to a weight.
